(19) United States
(12) Patent Application Publication
(10) Pub. No.: US 2025/0111111 A1
(43) Pub. Date: Apr. 3, 2025

(54) METHODS AND APPARATUS TO QUANTIFY EFFECTIVENESS OF CLOCK GATING IMPLEMENTATIONS IN ELECTRONIC DESIGN AUTOMATION

(71) Applicant: Intel Corporation, Santa Clara, CA (US)

(72) Inventors: John W. Cressman, Hudson, MA (US); Arun Subbiah, Folsom, CA (US); Nitya Ananthula, San Jose, CA (US); Wayne Szeto, Folsom, CA (US)

(21) Appl. No.: 18/478,499

(22) Filed: Sep. 29, 2023

(51) Int. Cl. G06F 30/31

(52) U.S. Cl. CPC G06F 30/31

(57) ABSTRACT

Example methods, apparatus, systems and articles of manufacture (e.g., physical computer readable storage media) to quantify effectiveness of clock gating implementations in electronic design automation are disclosed. Example methods disclosed herein include executing a first iteration of an electronic design automation (EDA) tool with clock gating of an input circuit design enabled to determine a gated power metric for a clock path of the input circuit design, executing a second iteration of the EDA tool with clock gating of the input circuit design disabled to determine an ungated power metric for the clock path of the input circuit design, and outputting a first efficiency metric for the clock path of the input circuit design based on the gated power metric and the ungated power metric.

### FIELD OF THE DISCLOSURE

This disclosure relates generally to electronic design automation and, more particularly, to quantifying effectiveness of clock gating implementations in electronic design automation.

### BACKGROUND

Modern electronic design automation (EDA) tools employ multiple design optimization techniques to perform synthesis and placement of circuit designs, such as system-on-a-chip (SoC) designs. Clock distribution networks in a circuit design can contribute substantially to total design power. Thus, EDA tools are used by circuit designers to implement clock gating to reduce dynamic power associated with capacitive charging and discharging of the clock cells. Dynamic Clock Gating Efficiency (DCGE) is a metric output by existing EDA tools to represent the effectiveness of a clock gating implementation.

### BRIEF DESCRIPTION OF THE DRAWINGS

FIG. 1 illustrates clock paths with different clock gating implementations for which effectiveness can be quantified in accordance with teachings of this disclosure.

FIG. 2 is a block diagram of an example environment in which an example EDA tool is implemented in accordance with teachings of this disclosure to quantify effectiveness of clock gating implementations.

FIG. 3 is a block diagram of an example clock path processed by the example EDA tool of FIG. 2.

FIGS. 4-7 are flowcharts representative of example machine readable instructions and/or example operations that may be executed, instantiated, and/or performed by example programmable circuitry to implement the EDA tool of FIG. 2.

FIG. 8 is a block diagram of an example processing platform including programmable circuitry structured to execute, instantiate, and/or perform the example machine readable instructions and/or perform the example operations of FIGS. 4-7 to implement the EDA tool of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 4-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Example methods, apparatus, systems and articles of manufacture (e.g., physical computer readable storage media) to quantify effectiveness of clock gating implementations in electronic design automation are disclosed herein. Clock distribution networks in a circuit design can contribute substantially to total design power, potentially ranging from 35% to 80% or more of partition power depending on workload and/or design implementation.

EDA tools are used by circuit designers to implement clock gating, which can reduce dynamic power associated with clock distribution networks. A metric used by industry to represent the effectiveness of a clock gating implementation is Dynamic Clock Gating Efficiency (DCGE).

DCGE is a measure of the clock activity reduction resulting from clock gating. DCGE is used in industry as a proxy for estimating an associated clock power utilization of the gated clock path. In particular, DCGE as reported by existing EDA tools analyzes the clock activity reduction for a clock path of a circuit design based on Equation 1, which is:

$$D C G E = 1 - ( {TR}_{LOCAL \_ CLK} / {TR}_{ROOT \_ CLK} ) \qquad Equation 1$$

In Equation 1, TR_{LOCAL_CLK} represents that toggle rate of the local clock at which DCGE is measured in the clock path, and TR_{ROOT_CLK} represents that toggle rate of the root clock (e.g., the global clock) at the root, or source, of the clock path. Circuit designers have utilized the DCGE metrics output by EDA tools to iterate design changes to improve DCGE and meet established DCGE targets (e.g., DCGE 85-100%) for a given workload.

However, the DCGE metric as previously used by industry as a proxy for power efficiency can misrepresent the effectiveness in saving power, thereby causing power reduction opportunities to be missed, which can be a substantial limitation of the DCGE metric. Utilizing DCGE as a proxy for power efficiency is that DCGE can misrepresent the effectiveness of a clock gate implementation for saving power. This is because utilizing DCGE as a proxy for power efficiency assumes that power is reduced at a rate equal to or at least proportional to the clock activity reduction measured by DCGE, which may not be true. Instead, two designs with identical sequential endpoint counts and identical DCGE metrics can differ in clock network power utilization due to architectural and/or physical implementation differences, such as when one of the designs utilizes an ineffective clock gating implementation. Design inefficiencies can go undetected with DCGE, resulting in unnecessary power dissipation.

To overcome at least some of the drawbacks associated with using DCGE as a proxy for power efficiency, example EDA tools disclosed herein measure and output a new metric, referred to as Effective Clock Gating Efficiency (ECGE). ECGE, which is disclosed in further detail below, represents the effectiveness of clock gating solutions in terms of how effectively power is reduced, rather than the activity reduction (e.g., toggle rate reduction) achieved by the clock paths in a circuit design. Thus, ECGE provides the rate of power savings achieved by a given clock path. Furthermore, ECGE can be compared against DCGE for that clock path, which represents the achievable (e.g., maximum possible) power reduction rate. The lower the ECGE, the larger the gap between actual power saved and the achievable (e.g., maximum possible) power savings that could be achieved for the clock path at the given DCGE level.

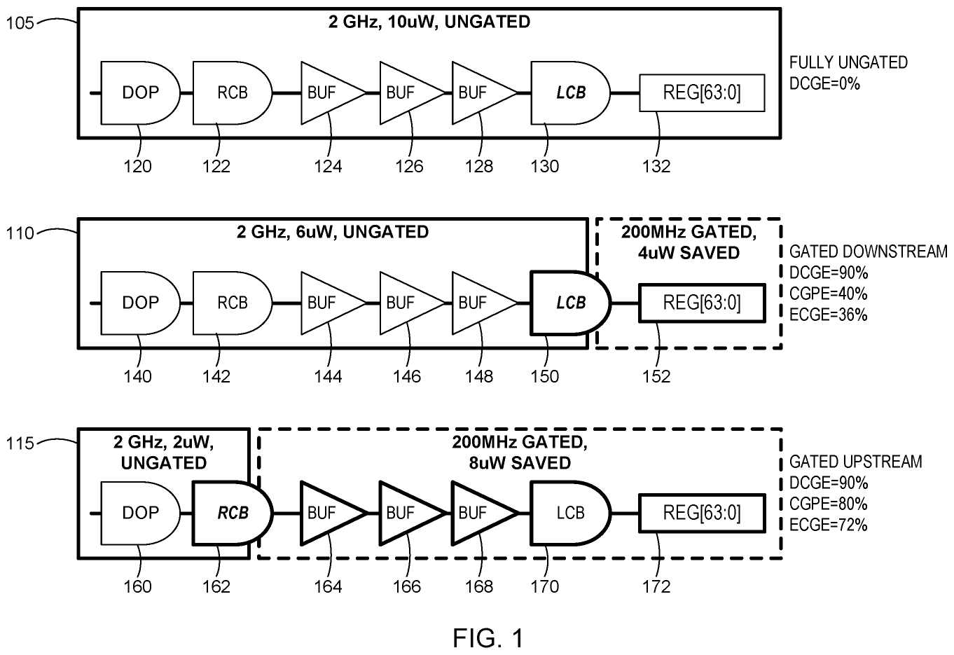

FIG. 1 illustrates example clock paths 105, 110 and 115 with different clock gating implementations for which effectiveness can be quantified by ECGE in accordance with teachings of this disclosure. In the example clock paths 105, 110 and 115, logic AND gates (e.g., corresponding to the rounded shapes in the figures) represent clock cells at which clock gating is or could be implemented. Clock gating causes the toggle rate at that output of a clock cell to be a fraction of the toggle rate at the input to that clock cell. In the example clock paths 105, 110 and 115, logic buffer gates (e.g., corresponding to the triangular shapes in the figures) represent clock buffer cells at which clock gating is not implemented. The example clock path 105 of FIG. 1 is an ungated clock path provided for reference, whereas the clock paths 110 and 115 utilize two different clock gating implementations that reduce clock activity to achieve the same DCGE metric (e.g., DCGE=90%). However, the gated clock paths 110 and 115 exhibit much different ECGE metrics (e.g., ECGE=44% for clock path 110 vs. ECGE=89% for clock path 115), which indicate that the clock gating implementation of the clock path 115 achieves a larger power reduction than the clock gating implementation of the clock path 110.

Examining the example clock paths of FIG. 1 more closely, the clock path 105, which is ungated, includes an example drop off point (DOP) clock 120 (which is also referred to as an example root clock 120 or global clock buffer 120 of that clock path), an example regional clock buffer (RCB) 122, additional example clock buffers 124-128 to support clock fanout, an example local clock buffer (LCB) 130, and example sequential logic 132 (e.g., an example register 132) that is driven by the LCB 130. In the illustrated example, DCGE is measured at the LCB 130 (e.g., by measuring the DCGE at the clock input pin of the register 132), which is the target clock at which clock gating effectiveness is analyzed. Because the clock path 105 is ungated and, thus, the LCB 130 toggles at the same rate (e.g., 2 GHZ in the illustrated example) as the DOP 120, the DCGE for clock path 105 is computed (e.g., by the EDA tool 200 described in further detail below) via Equation 1 to be 0%. Further, the power utilization of the clock path 105 (e.g., as determined by the EDA tool 200) is 10 μW.

In the illustrated example of FIG. 1, the clock path 110, which has a first gating implementation, includes an example DOP clock 140 (which is also referred to as an example root clock 140 or global clock buffer 140 of that clock path), an example RCB 142, additional example clock buffers 144-148 to support clock fanout, an example LCB 150, and example sequential logic 152 (e.g., an example register 152) that is driven by the LCB 150. In the illustrated example, DCGE is measured at the LCB 150, which is the target clock at which clock gating effectiveness is analyzed. In the clock path 110, clock gating is implemented at the LCB 150 such that the LCB 150 toggles at one-tenth the rate (e.g., 200 MHz in the illustrated example) of the DOP 140 (e.g., 2 GHz in the illustrated example). Thus, the DCGE for clock path 110 is computed (e.g., by the EDA tool 200 described in further detail below) via Equation 1 to be 90%. Further, the power utilization of the clock path 110 (e.g., as determined by the EDA tool 200) is 6 μW, which is a 4 μW power savings relative to the power utilization of the ungated clock path 105, and is a result of clocking the LCB 150 and the sequential logic 152 at a lower toggle rate. However, this results in a reduction in power of the clock path 110 of just 40% relative to the 10 μW of the ungated clock path power 105, which is much less than 90% reduction indicated by the DCGE for clock path 110. As disclosed in further detail below, this reduction in clock path power is represented by a Clock Gate Power Efficiency (CPGE) metric, and results in an ECGE of 44% for the clock path 110. As disclosed in further detail below, ECGE can be calculated by dividing CPGE by DCGE, and represents how close the actual CPGE for a clock path is to the DCGE, which represents the theoretical achievable (e.g., maximum possible) power reduction.

In the illustrated example of FIG. 1, the clock path 115, which has a second gating implementation, includes an example DOP clock 160 (which is also referred to as an example root clock 160 or global clock buffer 160 of that clock path), an example RCB 162, additional example clock buffers 164-168 to support clock fanout, an example LCB 170, and example sequential logic 172 (e.g., an example register 172) that is driven by the LCB 150. In the illustrated example, DCGE is measured at the LCB 170, which is the target clock at which clock gating effectiveness is analyzed. In the clock path 115, clock gating is implemented at the RCB 162 such that the RCB 162, the clock buffers 164-168, and the LCB 170 all toggle at one-tenth the rate (e.g., 200 MHz in the illustrated example) of the DOP 160 (e.g., 2 GHZ in the illustrated example). Thus, the DCGE for clock path 115 is computed (e.g., by the EDA tool 200 described in further detail below) via Equation 1 to be 90%, which is the same as the DCGE for the clock path 110. However, the power utilization of the clock path 110 (e.g., as determined by the EDA tool 200) is just 2 μW, which is an 8 μW power savings relative to the power utilization of the ungated clock path 105, and is a result of clocking the RCB 162, the clock buffers 164-168, the LCB 170 and the sequential logic 172 at a lower toggle rate. This results in a reduction in power of the clock path 110 of CPGE=80% relative to the 10 μW of the ungated clock path power 105, which is much closer to the 90% reduction indicated by the DCGE for clock path 115 than the clock path 110 was able to achieve. Furthermore, the ECGE for the clock path 110 is 89%, which quantifies how much closer the clock path 115 is able to reach the theoretical achievable (e.g., maximum) power reduction than the clock path 110 is.

As the example of FIG. 1 illustrates, different clock paths with the same DCGE can have much different power utilizations based on different clock gating implementations. The ECGE metric is able to quantify how effective a given clock gating implementation is relative to the theoretical achievable (e.g., maximum) power reduction represented by the DCGE, with higher ECGE values indicating a given clock gating implementation is more effective in reducing power utilization for that clock path.

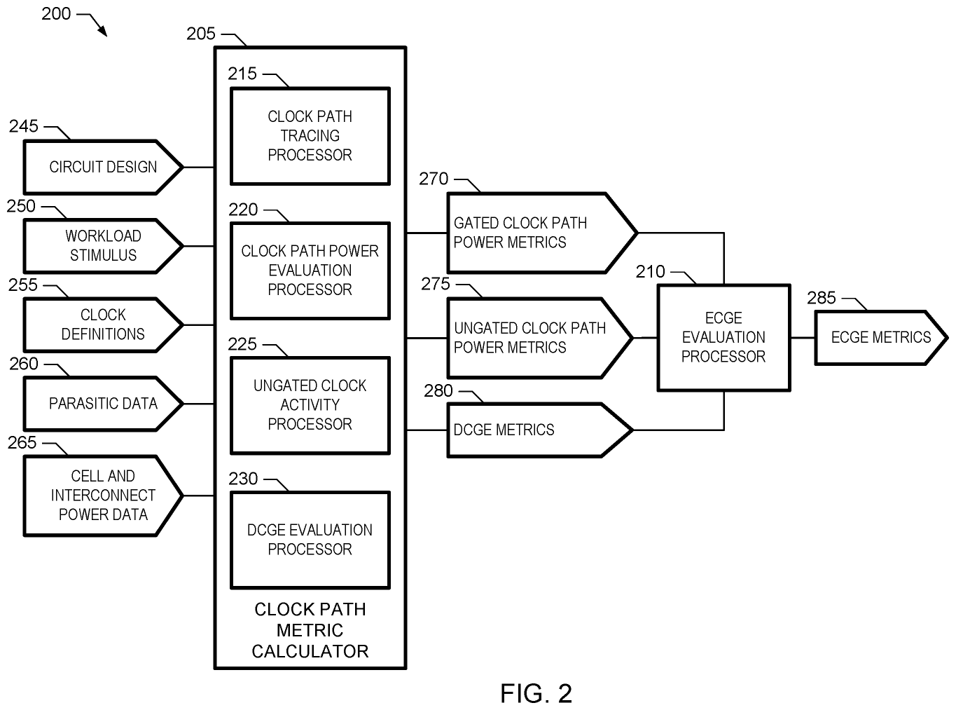

FIG. 2 is a block diagram of an example EDA tool 200 implemented in accordance with teachings of this disclosure to quantify effectiveness of clock gating implementations. The EDA tool 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the EDA tool 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example EDA tool 200 of FIG. 2 includes an example clock path metric calculator 205 and an example ECGE evaluation processor 210. The clock path metric calculator 205 of the illustrated example further includes an example clock path tracing processor 215, an example clock path power evaluation processor 220, an example ungated clock activity processor 225, and an example DCGE evaluation processor 230. Example of EDA tools that could be adapted to include or interoperate with the clock path metric calculator 205 and the ECGE evaluation processor 210 include, but are not limited to, Fusion Compiler™ by Synopsys®, Design Compiler® by Synopsys®, RTL Architect™ by Synopsys®, Innovus™ Implementation System by Cadence® Genus™ Synthesis Solution by Cadence®, Cadence® Joules™ RTL Design Studio, Cadence® Voltus™ IC Power Integrity Solution, etc.

The EDA tool 200 includes the clock path metric calculator 205 and the ECGE evaluation processor 210 to compute ECGE metrics for clock paths in an example circuit design 245 input to the EDA tool 200. In some examples, the circuit design 245 can be a logical circuit design, such as in the form of a register transfer level (RTL) abstraction written in a hardware description language (HDL) that provides a logical abstract of the circuit design, such as an SoC circuit design. Additionally or alternatively, in some examples, the circuit design 245 can be a physical circuit design, such as in the form of a netlist.

The ECGE metric determined by the EDA tool 200 measures the power reduction computed for a clock path of the input circuit design 245 with a particular clock gating implementation, relative to the achievable (e.g., maximum) theoretical power reduction represented by the DCGE metric for that clock path. As noted above in the description of FIG. 1, power reduction achieved by a given clock gating implementation is represented by the CPGE metric for that clock path. In most scenarios, the CPGE cannot exceed the DCGE for a given clock path because the achievable (e.g., maximum) dynamic power savings cannot exceed the rate of clock activity reduction. Because the CGPE for a given clock path is bounded by the DCGE for that clock path, the EDA tool 200 divides the CGPE for a clock path by the DCGE for the clock path to arrive at the ECGE result for the clock path. Scaling in this way provides a range of 0% to 100% for ECGE, where 100% represents the ideal achievable (e.g., maximum possible) power reduction efficiency for the given DCGE of the clock path. For example, if the DCGE metric for a given clock path is 50%, the CGPE for that clock path cannot exceed 50%. In that example with CGPE=50% and DCGE=50%, the ECGE is determined as 50/50=100%. Using both ECGE and DCGE provides a complete picture of both activity reduction and power efficiency achieved by the input circuit design 245.

The clock path metric calculator 205 includes the clock path tracing processor 215 and the clock path power evaluation processor 220 to determine the clock path power for different clock paths identified in the input circuit design 245. To do so, the clock path tracing processor 215 and the clock path power evaluation processor 220 utilize the input circuit design 245, as well as other input information, such as example workload stimulus input data 250, example clock definitions 255, example parasitic data 260 and example cell and interconnect power data 265. Clock path power depends on the clocking characteristics and the workload applied to the circuit design 245. Accordingly, the clock definitions 255 include data in any format specifying the set of nets which are root or source clocks (e.g., the DOP clocks 120, 140 and 160) of the circuit design 245. The workload stimulus input data 250 specifies the input signal workload to be applied to the circuit design 245, including the root clock toggle rates and duty cycles, which can be in any format, such as a fast signal database (FSDB) from an RTL simulation, a value change dump (VCD) file, etc.

In the illustrated example, the clock path power evaluation processor 220 determines the clock path power dissipated by a clock distribution path from a root clock to group of sequential logic endpoints. Determining CGPE for a given target clock gate (e.g., such as the LCB 150 or RCB 162 of FIG. 1) involves deriving the clock power in the clock network to reach the sequential logic driven by that target clock gate from the upstream root clock. This trace is referred to herein as a clock path. In this disclosure, the terms clock, clock gate, clock buffer, clock cell, clock node, clock driver, etc., are synonymous and used interchangeably unless noted otherwise.

In the illustrated example, the clock path tracing processor 215 determines a clock path as follows. Starting from a root clock in the circuit design 245, the clock path tracing processor 215 traces through the downstream cells in the fanout of the root clock through the subsequent stages of the circuit design 245 until a sequential logic element or other logic cell that is not a clock cell (e.g., a memory cell) is reached. When the clock path tracing processor 215 completes its tracing operations, each clock cell has a set of sequential logic endpoints associated with it. Additionally, each sequential logic endpoint has a clock path associated with it, which includes the set of clock drivers which make up that clock path.

For a given clock path identified by the clock path tracing processor 215, the clock path power evaluation processor 220 calculates an upstream clock power metric and a downstream clock power metric relative to a target clock cell (e.g., a local clock buffer) in that clock path. In the illustrated example, the clock path power evaluation processor 220 utilizes the parasitic data 260 and the cell and interconnect power data 265 in its power metric calculation. The parasitic data 260 includes data in any format specifying resistive and/or capacitive parasitic characteristics of the circuit elements in the input circuit design 245, such as the clock cells, the sequential logic cells, the memory cells, the interconnects between cells, etc. The cell and interconnect power data 265 includes data in any format specifying power utilization data for the different cells and interconnects included in the input circuit design 245.

The upstream clock power calculated by the clock path power evaluation processor 220 for a target clock gate is useful as it represents much of the power overhead cost to implement that target clock gate. This upstream clock power impacts effectiveness of the clock gating implementation up to that target gate because the upstream clock power is not reduced via downstream clock activity reductions (e.g., downstream clock gating). Clock gating implemented further upstream results in more power savings and thus higher ECGE, an attribute not captured by the DCGE metric.

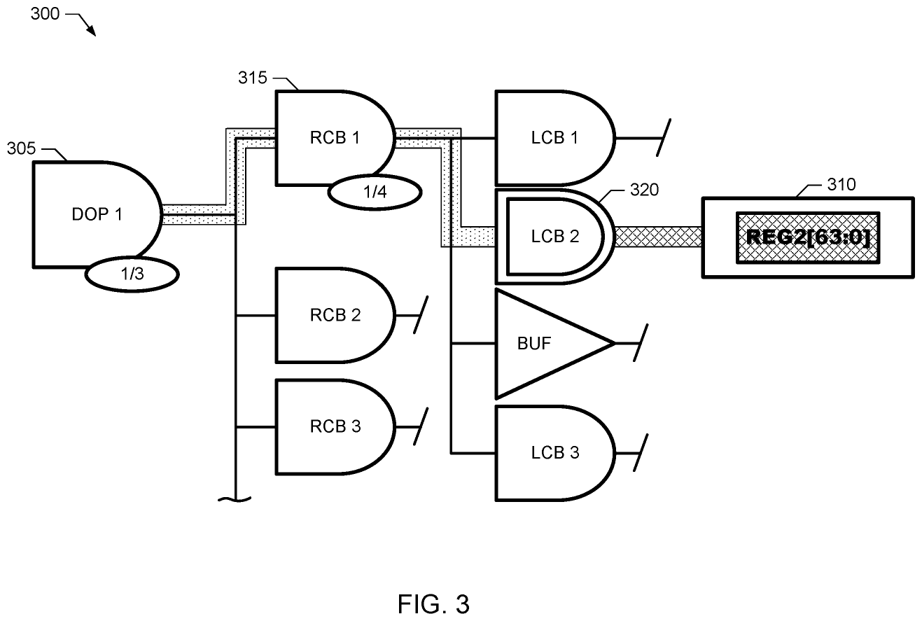

FIG. 3 illustrates an example clock network 300 traced by the example clock path tracing processor 215 and analyzed by the clock path power evaluation processor 220 of the EDA tool 200. FIG. 3 also illustrates how the clock path power evaluation processor 220 accounts for clock driver fanout to other clock cells not on a given clock path to a given sequential logic cell or group of sequential logic cells.

In the illustrated example, the clock path power evaluation processor 220 considers each downstream clock cell is responsible for upstream power proportional to its footprint in the fanout. In other words, each receiver clock cell of a driver clock cell with a fanout equal to N is considered responsible for 1/N of the driver clock cell's power. This is because, if not for that receiver clock cell, the driver clock cell and output fanout routes could otherwise have been proportionally reduced. However, this scale factor of 1/N is an approximation given that interconnect capacitance and receiver pin capacitance can vary across receiver clock cells. Thus, in some examples, the clock path power evaluation processor 220 supports a configuration option that causes the clock path power evaluation processor 220 to utilize the parasitic data 260 and/or the cell and interconnect power data 265 to set the scale factor to a value other than 1/N based on the traced receiver pin capacitance relative to total capacitance of all receivers for the particular driver clock cell being analyzed.

The following is an example calculation performed by the clock path power evaluation processor 220 to determine, or estimate, the clock path power for an example clock path traced by the clock path tracing processor 215 in the clock network 300 of FIG. 3 from an example root clock 305 (represented by DOP1 in FIG. 3) to an example sequential logic cell 310 (represented by example register REG2 in FIG. 3). The clock path includes the root clock cell 305, an example intermediate clock cell 315 (represented by RCB1 in FIG. 3), and an example target clock cell 320 (represented by LCB2 in FIG. 3). In the illustrated example, the clock path power evaluation processor 220 calculates the upstream clock power metric for the clock path to include one-third (⅓) of the internal and output load power associated with the root clock cell 305, because the root clock cell 305 has a fanout of 3 and the next clock cell in the path—the intermediate clock cell 315—is responsible for ⅓ of that total fanout. In the illustrated example, the clock path power evaluation processor 220 calculates the upstream clock power metric for the clock path to also include one-fourth (¼) of the internal and output load power associated with the intermediate clock cell 315, because the intermediate clock cell 315 has a fanout of 4 and the next clock cell in the path—the target clock cell 320—is responsible for ¼ of that total fanout. In the illustrated example, the clock path power evaluation processor 220 calculates the upstream clock power metric for the clock path to further include the internal power associated with the target clock cell 320. Thus, the upstream clock power metric calculated by the clock path power evaluation processor 220 for the example clock path including the target clock cell 320 can be represented mathematically by Equation 2, which is:

$$Upstream Clock Power ( LCB 2 ) = 1 / 3 DOP 1 ( internal + output load ) + 1 / 4 RCB 1 ( internal + output load ) + LCB 2 ( internal ) \qquad Equation 2$$

In Equation 2, “internal” refers to the internal power of the clock cell, which is a function of the input pin toggle rate and characterized cell power, “output load” refers to the output power of the clock cell, which is a function of the output pin toggle rate and output routing interconnect capacitance and receiver pin capacitance (e.g., as provided in the parasitic data 260 and/or the cell and interconnect power data 265). When gating is applied at a clock cell, a portion of the internal power continues to be dissipated due to the input clock pin switching, which is why the internal power of a clock cell is categorized by the clock path power evaluation processor 220 as part of the upstream clock power. Because the upstream clock power is a function of the workload applied to the circuit design 245, the clock path power evaluation processor 220 calculates the internal powers and the output powers of the clock cells based on the input workload stimulus 250.

In the illustrated example, the clock path power evaluation processor 220 calculates the downstream clock power metric for a clock path to include the output power of the clock cell(s) down to the sequential logic endpoint(s), which includes the internal clock power of the sequential logic endpoint(s). For example, the clock path power evaluation processor 220 calculates the downstream clock power metric for the example clock path to include the output power of the target clock cell 320 and the internal clock power of the sequential logic 310. Thus, the downstream clock power metric calculated by the clock path power evaluation processor 220 for the example clock path including the target clock cell 320 can be represented mathematically by Equation 3, which is:

$$Downstream Clock Power ( LCB 2 ) = LCB 2 ( output load ) + REG 2 [ 63 : 0 ] ( clock internal ) \qquad Equation 3$$

Because the downstream clock power is function of the workload applied to the circuit design 245, the clock path power evaluation processor 220 calculates the output load powers and the clock internal powers based on the input workload stimulus 250.

In the illustrated example, the clock path power evaluation processor 220 calculates the overall clock path power metric for the example clock path based on the upstream clock power metric and the downstream clock power metric determined for that clock path. For example, the clock path power evaluation processor 220 calculates the overall clock path power metric for the example clock path to be the sum of the upstream clock power metric and the downstream clock power metric as shown mathematically in Equation 4, which is:

$$Clock Path {Power}_{WORKLOAD} = Upstream Clock Power + Downstream Clock Power \qquad Equation 4$$

As disclosed in further detail below, the overall clock path power is used to calculate the CGPE for the clock path. However, the clock path power evaluation processor 220 separates the clock path power into upstream and downstream components to isolate which power is overhead and which is addressed by the gating element.

Returning to FIG. 2, the ECGE evaluation processor 210 calculates CGPE and ECGE for the clock paths of one or more, or all, of the clock cells and sequential logic cells in the input circuit design 245. This analysis can be applied to logical (e.g., RTL) and/or physical (e.g., netlist) circuit designs. For example, RTL-based analysis can flag architectural inefficiencies with clock gating, whereas physical-based analysis can flag issues with clock tree synthesis and meshes, physical clock gating and/or other construction flow issues that could otherwise go undetected.

In the illustrated example, the ECGE evaluation processor 210 calculates CGPE for a given clock path based on a gated power metric for the clock path and an ungated power metric for the clock path. For example, the gated power metric corresponds to the overall clock path power metric Clock Path Power_{WORKLOAD} described above, and the ungated power metric corresponds to an ungated version of that clock path power metric, which is represented by Clock Path Power_{UNGATED} and described in further detail below. In some examples, the ECGE evaluation processor 210 calculates the CGPE for a given clock path to be one minus the Clock Path Power_{WORKLOAD} metric divided by the Clock Path Power_{UNGATED} metric, which is shown mathematically in Equation 5, which is:

$${CGPE}_{CLOCK PATH WORKLOAD} = 1 - Clock Path {Power}_{WORKLOAD} / Clock Path {Power}_{UNGATED} \qquad Equation 5$$

The ECGE evaluation processor 210 of the illustrated examples then calculates the ECGE for the given clock path by dividing the CGPE_{CLOCK PATH} metric determined for that given clock path by the DCGE_{CLOCK PATH} metric for that clock path, which is represented mathematically by Equation 6, which is:

$${ECGE}_{CLOCK PATH} = {CGPE}_{CLOCK PATH WORKLOAD} / D C G {E}_{CLOCK PATH WORKLOAD} \qquad Equation 6$$

Because the ECGE evaluation processor 210 utilizes the DCGE_{CLOCK PATH WORKLOAD} metric to calculate the ECGE_{CLOCK PATH} for a given clock path, the clock path metric calculator 205 includes the DCGE evaluation processor 230. The DCGE evaluation processor 230 calculates DCGE metrics for the clock paths of one or more, or all, of the clock cells and sequential logic cells in the input circuit design 245. For example, the DCGE evaluation processor 230 calculates the DCGE metrics in accordance with Equation 1 and the description of FIG. 1 provided above.

Because the ECGE evaluation processor 210 utilizes the ungated version of that clock path power metric, Clock Path Power_{UNGATED}, in its calculation of CGPE for a given clock path, the clock path metric calculator 205 includes the ungated clock activity processor 225. As noted above, CGPE utilizes an evaluation of the clock path power under the condition that no clock gating is applied during a workload. The challenge is that the ungated clock path power may not be determinable in the process iteration of the EDA tool 200 described above (in which workload power analysis is conducted) because many of the clocks may be gated.

Thus, the ungated clock activity processor 225 causes the EDA tool 200 to execute a second process iteration to perform an “ungated” run to capture a “what-if” power analysis of the clock network with all clock gating disabled. In some examples, to execute the ungated process iteration, the ungated clock activity processor 225 clears out the design activity from the preceding, gated process iteration and, for each clock path to be analyzed, applies the root clock toggle rate to the clock cells between the root clock and sequential logic endpoint(s) of the clock path. The ungated clock activity processor 225 then invokes the clock path power evaluation processor 220 to perform the power calculations described above to determine the reference ungated clock path power metric, Clock Path Power_{UNGATED}, for each clock path of interest. In some examples, power associated with data activity is removed from the clock path power calculations.

In some examples, the ungated run uses a vector-less mode with statistical propagation where the ungated clock activity processor 225 applies the correct ungated activity on the entire clock network. In some such examples, each clock cell that fans out from a particular root clock is overridden by the ungated clock activity processor 225 with root clock activity determined from the prior gated workload process iteration to cause that cell to operate as if it is not gated. In some such examples, the ungated clock activity processor 225 applies a default toggle rate of zero (0) to the rest of the logic gates of the circuit design 245 to ensure no activity associated with that non-clock logic impacts the ungated clock path power metric(s), Clock Path Power_{UNGATED}, determined for the clock paths of interest. For example, in the ungated run, clock path activity may be overridden to the root clock frequency for all cells (e.g., clock cells and non-clock cells) in the clock path of interest. Furthermore, the enable pin(s), or other side input pin(s), of the other clock cell(s) not included in (e.g., adjacent to) the clock path of interest could be set to have a toggle rate of 0, thereby also causing the toggle rate of the other logic gates not included in (e.g., adjacent to) the clock path to be set to 0. In some examples, root clock information (e.g., clock names and activity) is derived from the prior gated workload process iterations.

Thus, in the illustrated example of FIG. 2, the clock path metric calculator 205 of the EDA tool 200 outputs example gated clock path power metric(s) 270 (e.g., Clock Path Power_{WORKLOAD}) determined by the clock path power evaluation processor 220 for the clock path(s) of interest via execution of a first process iteration of the EDA tool 200 with clock gating enabled. The example clock path metric calculator 205 also outputs example ungated clock path power metric(s) 275 (e.g., Clock Path Power_{UNGATED}) determined by the clock path power evaluation processor 220 for the clock path(s) of interest via execution of a second process iteration of the EDA tool 200 with clock gating disabled, as described above. The example clock path metric calculator 205 further outputs example DCGE metric(s) 280 (e.g., DCGE_{CLOCK PATH}) determined by the DCGE evaluation processor 230 for the clock path(s) as part of execution of the first process iteration of the EDA tool 200 with clock gating enabled.

In the illustrated example, the ECGE evaluation processor 210 operates on the gated clock path power metric(s) 270, the ungated clock path power metric(s) 275 and the DCGE metric(s) 280 using Equations 5 and 6, as described above, to output example ECGE metrics 285 (e.g., ECGE_{CLOCK PATH}) for the clock paths of interest. In some examples, the ECGE evaluation processor 210 generates and outputs detailed reports, graphical displays, etc., providing the ECGE metrics for individual clock paths, histograms counting numbers of clock paths in different ECGE ranges (e.g., bins), etc. In some examples, the ECGE evaluation processor 210 also outputs one or more of the other metrics determined for the clock paths of interest (e.g., such as CGPE_{CLOCK PATH} WORKLOAD, DCGE_{CLOCK PATH} WORKLOAD, Clock Path Power_{WORKLOAD}, Clock Path Power_{UNGATED}, Upstream Clock Power, Downstream Clock Power, etc.). For example, the metrics to be output by the ECGE evaluation processor 210 can be specified by configuration data provided to the ECGE evaluation processor 210.

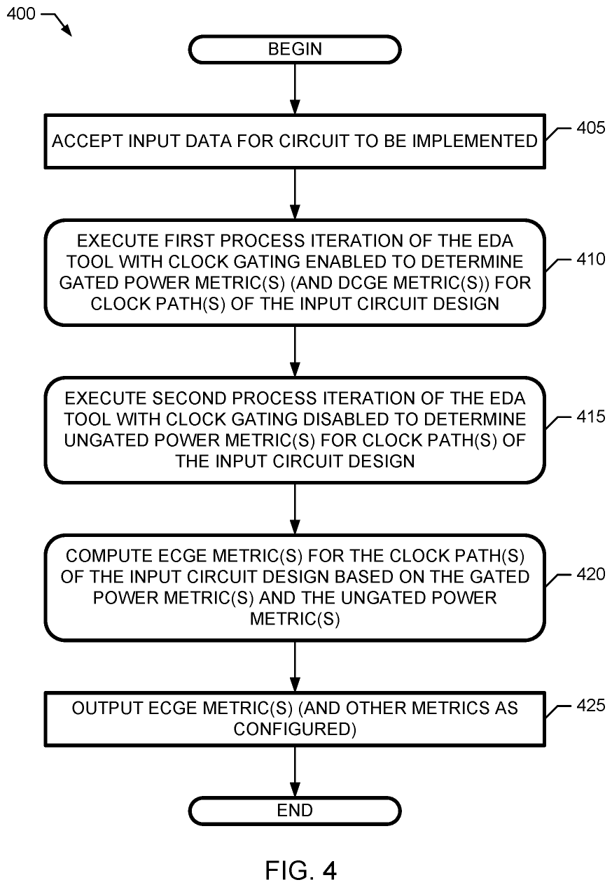

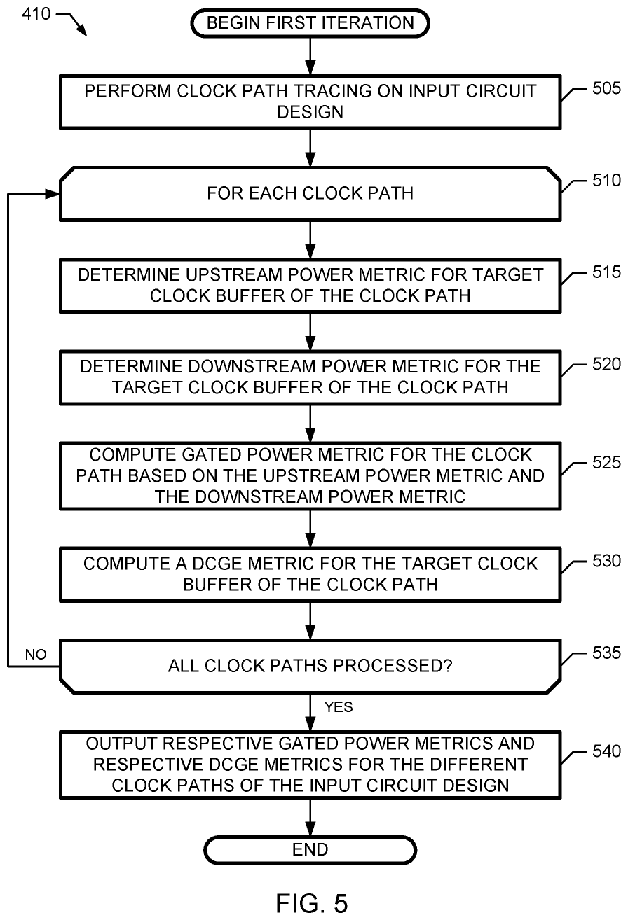

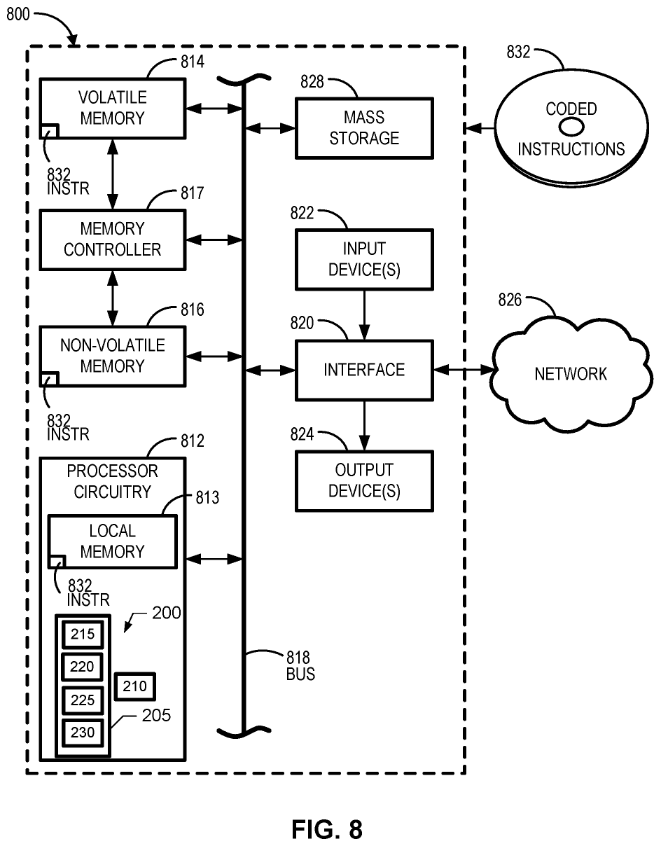

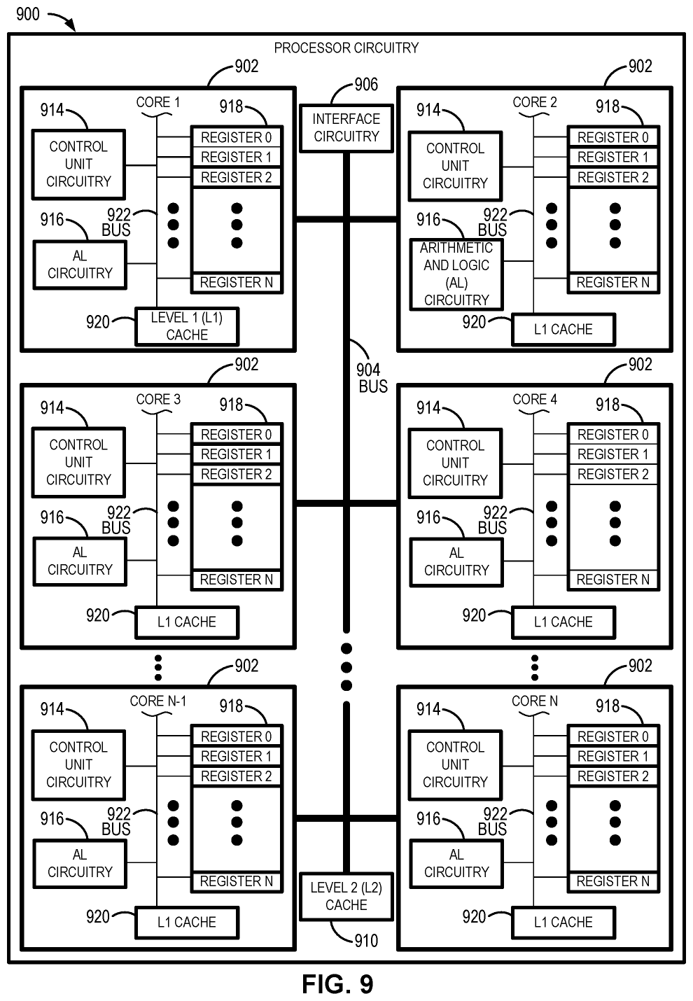

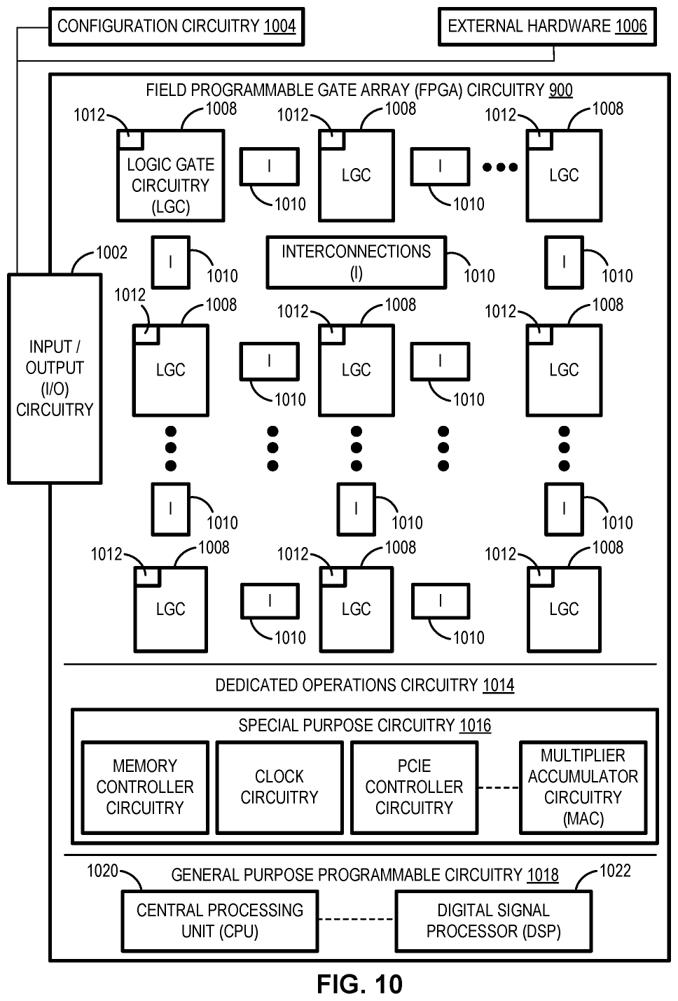

In some examples, the EDA tool 200 includes means for tracing clock paths of a circuit design. For example, the means for tracing clock paths may be implemented by the clock path tracing processor 215. In some examples, the clock path tracing processor 215 may be instantiated by programmable circuitry such as the example programmable circuitry 812 of FIG. 8. For instance, the clock path tracing processor 215 may be instantiated by the example microprocessor 900 of FIG. 9 executing machine executable instructions such as those implemented by blocks of FIGS. 4 and 5. In some examples, the clock path tracing processor 215 may be instantiated by hardware logic circuitry, which may be implemented by an ASIC. XPU, or the FPGA circuitry 1000 of FIG. 10 configured and/or structured to perform operations corresponding to the machine readable instructions. Additionally or alternatively, the clock path tracing processor 215 may be instantiated by any other combination of hardware, software, and/or firmware. For example, the clock path tracing processor 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the EDA tool 200 includes means for evaluating clock path power of a circuit design. For example, the means for evaluating clock path power may be implemented by the clock path power evaluation processor 220. In some examples, the clock path power evaluation processor 220 may be instantiated by programmable circuitry such as the example programmable circuitry 812 of FIG. 8. For instance, the clock path power evaluation processor 220 may be instantiated by the example microprocessor 900 of FIG. 9 executing machine executable instructions such as those implemented by blocks of FIGS. 4-6. In some examples, the clock path power evaluation processor 220 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the clock path power evaluation processor 220 may be instantiated by any other combination of hardware, software, and/or firmware. For example, the clock path power evaluation processor 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

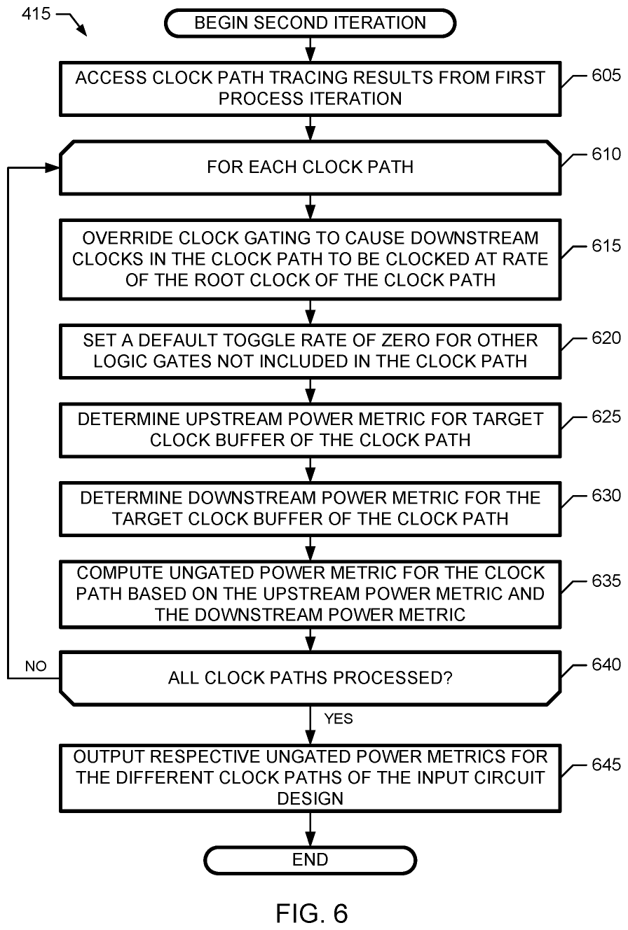

In some examples, the EDA tool 200 includes means for configuring evaluation of ungated clock activity associated with a circuit design. For example, the means for configuring evaluation of ungated clock activity may be implemented by the ungated clock activity processor 225. In some examples, the ungated clock activity processor 225 may be instantiated by programmable circuitry such as the example programmable circuitry 812 of FIG. 8. For instance, the ungated clock activity processor 225 may be instantiated by the example microprocessor 900 of FIG. 9 executing machine executable instructions such as those implemented by blocks of FIGS. 4 and 6. In some examples, the ungated clock activity processor 225 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the ungated clock activity processor 225 may be instantiated by any other combination of hardware, software, and/or firmware. For example, the ungated clock activity processor 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the EDA tool 200 includes means for evaluating DCGE of clock paths of a circuit design. For example, the means for evaluating DCGE may be implemented by the DCGE evaluation processor 230. In some examples, the DCGE evaluation processor 230 may be instantiated by programmable circuitry such as the example programmable circuitry 812 of FIG. 8. For instance, the DCGE evaluation processor 230 may be instantiated by the example microprocessor 900 of FIG. 9 executing machine executable instructions such as those implemented by blocks of FIG. 5. In some examples, the DCGE evaluation processor 230 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the DCGE evaluation processor 230 may be instantiated by any other combination of hardware, software, and/or firmware. For example, the DCGE evaluation processor 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

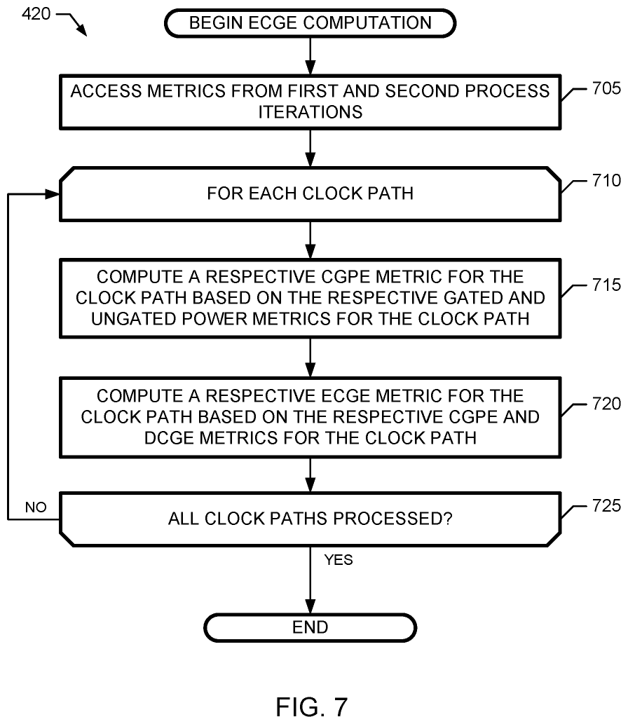

In some examples, the EDA tool 200 includes means for evaluating ECGE of clock paths of a circuit design. For example, the means for evaluating ECGE may be implemented by the ECGE evaluation processor 210. In some examples, the ECGE evaluation processor 210 may be instantiated by programmable circuitry such as the example programmable circuitry 812 of FIG. 8. For instance, the ECGE evaluation processor 210 may be instantiated by the example microprocessor 900 of FIG. 9 executing machine executable instructions such as those implemented by blocks of FIG. 7. In some examples, the ECGE evaluation processor 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the ECGE evaluation processor 210 may be instantiated by any other combination of hardware, software, and/or firmware. For example, the ECGE evaluation processor 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the EDA tool 200 is illustrated in FIG. 2, one or more of the elements, processes, and/or devices illustrated in FIG. 2 may be combined, divided, re-arranged, omitted, eliminated, and/or implemented in any other way. Further, the example clock path metric calculator 205, the example ECGE evaluation processor 210, the example clock path tracing processor 215, the example clock path power evaluation processor 220, the example ungated clock activity processor 225, the example DCGE evaluation processor 230 and/or, more generally, the example EDA tool 200 of FIG. 2 may be implemented by hardware alone or by hardware in combination with software and/or firmware. Thus, for example, any of the example clock path metric calculator 205, the example ECGE evaluation processor 210, the example clock path tracing processor 215, the example clock path power evaluation processor 220, the example ungated clock activity processor 225, the example DCGE evaluation processor 230, and/or, more generally, the example EDA tool 200 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example EDA tool 200 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the EDA tool 200 of FIG. 2 and/or representative of example operations which may be performed by programmable circuitry to implement and/or instantiate the EDA tool 200 of FIG. 2, are shown in FIGS. 4-7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-7, many other methods of implementing the example EDA tool 200 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B. (5) A with C. (6) B with C, or (7) A with B and with C. As used herein in the context of describing structures, components, items, objects and/or things, the phrase “at least one of A and B” is intended to refer to implementations including any of (1) at least one A. (2) at least one B, or (3) at least one A and at least one B. Similarly, as used herein in the context of describing structures, components, items, objects and/or things, the phrase “at least one of A or B” is intended to refer to implementations including any of (1) at least one A. (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

FIG. 4 is a flowchart representative of example machine readable instructions and/or example operations 400 that may be executed, instantiated, and/or performed by programmable circuitry to implement the example EDA tool 200. The example machine-readable instructions and/or the example operations 400 of FIG. 4 begin at block 405, at which the clock path metric calculator 205 of the EDA tool 200 accepts input data for a circuit to be implemented. For example, the input data accessed at block 405 can include the circuit design 245, workload stimulus input data 250, the clock definitions 255, parasitic data 260, and/or the cell and interconnect power data 265, as described above.

At block 410, the EDA tool 200 executes a first process iteration with clock gating enabled to determine gated power metric(s) and DCGE metric(s) for one or more clock paths of the input circuit design, as described above. Example machine-readable instructions and/or example operations that be used to implement the processing at block 410 of FIG. 4 are illustrated in FIG. 5, which is described in detail below.

At block 415, the EDA tool 200 executes a second process iteration with clock gating disabled to determine ungated power metric(s) for the one or more clock paths of the input circuit design, as described above. Example machine-readable instructions and/or example operations that be used to implement the processing at block 415 of FIG. 4 are illustrated in FIG. 6, which is described in detail below.

At block 420, the ECGE evaluation processor 210 of the EDA tool 200 computes, as described above, ECGE metric(s) for the one the one or more clock paths of the input circuit design based on the gated power metric(s) and the ungated power metric(s) (and the DCGE metric(s)) obtained at blocks 410 and 415. Example machine-readable instructions and/or example operations that be used to implement the processing at block 420 of FIG. 4 are illustrated in FIG. 7, which is described in detail below.

At block 425, the ECGE evaluation processor 210 outputs the ECGE metric(s), and any other metric(s) specified by configuration information, as described above. The example machine-readable instructions and/or the example operations 400 of FIG. 4 then end.

FIG. 5 is a flowchart representative of example machine readable instructions and/or example operations 410 that may be executed, instantiated, and/or performed by programmable circuitry to implement the example EDA tool 200 and, more specifically, the processing at block 410 of FIG. 4. The example machine-readable instructions and/or the example operations 410 of FIG. 5 begin at block 505, at which the clock path tracing processor 215 of the EDA tool 200 performs clock path tracing to identify clock paths in the input circuit design, as described above.

At block 510, the EDA tool 200 begins iterating over the clock paths identified in block 505. For a given clock path of the identified clock paths, at block 515, the clock path power evaluation processor 220 of the EDA tool 200 determines an upstream power metric relative to a target clock cell of the clock path, as described above. At block 520, the clock path power evaluation processor 220 determines a downstream power metric relative to the target clock cell of the clock path, as described above. At block 525, the clock path power evaluation processor 220 determines, as described above, a gated power metric (e.g., Clock Path Power_{WORKLOAD}) for the clock path based on the upstream power metric obtained at block 515 and the downstream power metric obtained at block 520. At block 530, the DCGE evaluation processor 230 of the EDA tool 200 determines a DCGE metric (e.g., DCGE_{CLOCK PATH}) for the clock path relative to the target clock cell, as described above. At block 535, the EDA tool 200 continues iterating over the identified clock paths until all clock paths of interest have been processed.

At block 540, the clock path metric calculator 205 of the EDA tool 200 outputs the respective gated clock power metrics 270 and the respective DCGE metrics 280 for the different clock paths of the input circuit design 245, as described above. The example machine-readable instructions and/or the example operations 410 then end.

FIG. 6 is a flowchart representative of example machine readable instructions and/or example operations 415 that may be executed, instantiated, and/or performed by programmable circuitry to implement the example EDA tool 200 and, more specifically, the processing at block 415 of FIG. 4. The example machine-readable instructions and/or the example operations 415 of FIG. 6 begin at block 605, at which the ungated clock activity processor 225 of the EDA tool 200 accessed the clock paths identified in the input circuit design from the first process iteration, as described above.

At block 610, the EDA tool 200 begins iterating over the clock paths identified in block 605. For a given clock path of the identified clock paths, at block 615, the ungated clock activity processor 225 overrides clock gating in the input circuit design 245 to cause downstream clocks in the given clock path to be clocked at the rate of the root clock of the clock path, as described above. At block 620, the ungated clock activity processor 225 sets a default toggle rate of zero (0) to the rest of the logic gates of the circuit design, as described above. At block 625, the clock path power evaluation processor 220 of the EDA tool 200 determines an upstream power metric (ungated) relative to a target clock cell of the clock path, as described above. At block 630, the clock path power evaluation processor 220 determines a downstream power metric (ungated) relative to the target clock cell of the clock path, as described above. At block 635, the clock path power evaluation processor 220 determines, as described above, an ungated power metric (e.g., Clock Path Power_{UNGATED}) for the clock path based on the upstream power metric obtained at block 625 and the downstream power metric obtained at block 630. At block 640, the EDA tool 200 continues iterating over the identified clock paths until all clock paths of interest have been processed.

At block 645, the clock path metric calculator 205 of the EDA tool 200 outputs the respective ungated gated clock power metrics 275 for the different clock paths of the input circuit design 245, as described above. The example machine-readable instructions and/or the example operations 415 then end.

FIG. 7 is a flowchart representative of example machine readable instructions and/or example operations 420 that may be executed, instantiated, and/or performed by programmable circuitry to implement the example EDA tool 200 and, more specifically, the processing at block 420 of FIG. 4. The example machine-readable instructions and/or the example operations 420 of FIG. 7 begin at block 705, at which the ECGE evaluation processor 210 of the EDA tool 200 access the gated clock power metrics 270, the ungated gated clock power metrics 275 and the respective DCGE metrics 280 obtained from execution of the first and second process iterations of the EDA tool.

At block 710, the EDA tool 200 begins iterating over the clock paths represented in the metrics obtained at block 705. For a given clock path, at block 720, the ECGE evaluation processor 210 computes a respective CGPE metric (e.g., CGPE_{CLOCK PATH}) for the clock path based on the respective gated and ungated power metrics (e.g., Clock Path Power_{WORKLOAD} and Clock Path Power_{UNGATED}) for the clock path based on Equation 5, as described above. At block 720, the ECGE evaluation processor 210 computes a respective ECGE metric (e.g., ECGE_{CLOCK PATH}) for the clock path based on the respective CGPE metric (e.g., CGPE_{CLOCK PATH}) and the respective DCGE metric (e.g., DCGE_{CLOCK PATH}) for the clock path, as described above. At block 725, the EDA tool 200 continues iterating over the clock paths until all clock paths of interest have been processed. The example machine-readable instructions and/or the example operations 415 then end.

FIG. 8 is a block diagram of an example programmable circuitry platform 800 structured to execute and/or instantiate the example machine-readable instructions and/or the example operations of FIGS. 4-7 to implement the EDA tool 200 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example clock path metric calculator 205, the example ECGE evaluation processor 210, the example clock path tracing processor 215, the example clock path power evaluation processor 220, the example ungated clock activity processor 225, and/or the example DCGE evaluation processor 230.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 4-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 4-7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 4-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 4-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-7. As such, the FPGA circuitry 1000 may be configured and/or structured to effectively instantiate some or all of the operations/functions corresponding to the machine readable instructions of the flowchart(s) of FIGS. 4-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 4-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 4-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 4-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIG. 4-7, and/or an ASIC may be configured and/or structured to perform third operation(s)/function(s) corresponding to a third portion of the machine readable instructions represented by the flowcharts of FIGS. 4-7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

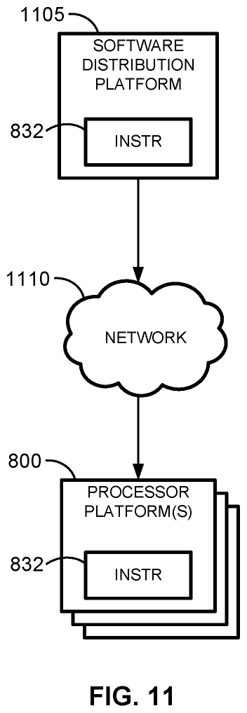

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 4-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 4-7, may be downloaded to the example programmable circuitry platform 800, which is to execute the machine readable instructions 832 to implement the EDA tool 200. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that quantify effectiveness of clock gating implementations in electronic design automation. Disclosed systems, apparatus, articles of manufacture, and methods improve the efficiency of using a computing device by computing an Effective Clock Gating Efficiency (ECGE) metric during synthesis of a circuit design with an EDA tool. The ECGE metric represents the effectiveness of a clock gating solution in terms of how effectively power is reduced. The ECGE metric can be used to evaluate and modify the clock gating solution in the circuit design to achieve a target power reduction. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes at least one non-transitory computer readable medium comprising computer readable instructions to cause programmable circuitry to at least execute a first iteration of an electronic design automation (EDA) tool with clock gating of an input circuit design enabled to determine a gated power metric for a clock path of the input circuit design, execute a second iteration of the EDA tool with clock gating of the input circuit design disabled to determine an ungated power metric for the clock path of the input circuit design, and output a first efficiency metric for the clock path of the input circuit design based on the gated power metric and the ungated power metric.

Example 2 includes the at least one non-transitory computer readable medium of example 1, wherein the first iteration of the EDA tool is to determine a second efficiency metric for the clock path of the input circuit design, the second efficiency metric based on clock activity associated with the clock path of the input circuit design, and the first efficiency metric is based on the gated power metric, the ungated power metric and the second efficiency metric.

Example 3 includes the at least one non-transitory computer readable medium of example 2, wherein the instructions are to cause the programmable circuitry to determine a third efficiency metric based on a ratio of the gated power metric and the ungated power metric, and the instructions are to cause the programmable circuitry to determine the first efficiency metric based on a ratio of the third efficiency metric and the second efficiency metric.

Example 4 includes the at least one non-transitory computer readable medium of example 1, wherein the gated power metric is based on an upstream power metric for the clock path and a downstream power metric for the clock path, the upstream power metric and the downstream power metric relative to a clock buffer in the clock path.

Example 5 includes the at least one non-transitory computer readable medium of example 4, wherein the clock buffer is a local clock buffer in the clock path, the upstream power metric is to estimate power utilization from a global clock buffer of the clock path to the local clock buffer, and the downstream power metric is to estimate power utilization from an output of the local clock buffer to a sequential logic cell driven by the local clock buffer, the upstream power metric to include power utilization of the local clock buffer, the downstream power metric to include power utilization of the sequential logic cell.

Example 6 includes the at least one non-transitory computer readable medium of example 4, wherein the instructions are to cause the programmable circuitry to output the upstream power metric for the clock path and the downstream power metric for the clock path.

Example 7 includes the at least one non-transitory computer readable medium of example 1, wherein to execute the second iteration of the EDA tool with clock gating of the input circuit design disabled, the instructions are to cause the programmable circuitry to override clock gating in the clock path by causing downstream clocks in the clock path to be clocked at a rate of a root clock of the clock path, and set a default toggle rate of zero for other logic gates and side input pins adjacent to the clock path.

Example 8 includes the at least one non-transitory computer readable medium of example 1, wherein the clock path is a first clock path, the gated power metric is a first gated power metric, the ungated power metric is a first ungated power metric, the first efficiency metric is a first effective clock gating efficiency metric, and the instructions are to cause the programmable circuitry to execute the first iteration of the EDA tool with clock gating of the input circuit design enabled to determine respective gated power metrics for respective clock paths of the input circuit design, the respective gated power metrics including the first gated power metric for the first clock path, execute the second iteration of the EDA tool with clock gating of the input circuit design disabled to determine respective ungated power metrics for the respective clock paths of the input circuit design, the respective ungated power metrics including the first ungated power metric for the first clock path, and output respective effective clock gating efficiency metrics for the respective clock paths of the input circuit design, the respective effective clock gating efficiency metrics based on the respective gated power metric and the respective ungated power metric, the respective effective clock gating efficiency metrics including the first effective clock gating efficiency metric for the first clock path.

Example 9 includes an apparatus comprising interface circuitry, computer readable instructions, and programmable circuitry to at least one of execute or instantiate the computer readable instructions to execute a first iteration of an electronic design automation (EDA) tool with clock gating of an input circuit design enabled to determine a gated power metric for a clock path of the input circuit design, execute a second iteration of the EDA tool with clock gating of the input circuit design disabled to determine an ungated power metric for the clock path of the input circuit design, and output a first efficiency metric for the clock path of the input circuit design based on the gated power metric and the ungated power metric.

Example 10 includes the apparatus of example 9, wherein the first iteration of the EDA tool is to determine a second efficiency metric for the clock path of the input circuit design, the second efficiency metric based on clock activity associated with the clock path of the input circuit design, and the first efficiency metric is based on the gated power metric, the ungated power metric and the second efficiency metric.

Example 11 includes the apparatus of example 10, wherein the programmable circuitry is to determine a third efficiency metric based on a ratio of the gated power metric and the ungated power metric, and determine the first efficiency metric based on a ratio of the third efficiency metric and the second efficiency metric.

Example 12 includes the apparatus of example 9, wherein the gated power metric is based on an upstream power metric for the clock path and a downstream power metric for the clock path, the upstream power metric and the downstream power metric relative to a clock buffer in the clock path.

Example 13 includes the apparatus of example 12, wherein the clock buffer is a local clock buffer in the clock path, the upstream power metric is to estimate power utilization from a global clock buffer of the clock path to the local clock buffer, and the downstream power metric is to estimate power utilization from an output of the local clock buffer to a sequential logic cell driven by the local clock buffer, the upstream power metric to include power utilization of the local clock buffer, the downstream power metric to include power utilization of the sequential logic cell.

Example 14 includes the apparatus of example 9, wherein to execute the second iteration of the EDA tool with clock gating of the input circuit design disabled, the programmable circuitry is to override clock gating in the clock path by causing downstream clocks in the clock path to be clocked at a rate of a root clock of the clock path, and set a default toggle rate of zero for other logic gates and side input pins adjacent to the clock path.

Example 15 includes a method comprising executing a first iteration of an electronic design automation (EDA) tool with clock gating of an input circuit design enabled to determine a gated power metric for a clock path of the input circuit design, executing a second iteration of the EDA tool with clock gating of the input circuit design disabled to determine an ungated power metric for the clock path of the input circuit design, and outputting a first efficiency metric for the clock path of the input circuit design based on the gated power metric and the ungated power metric.

Example 16 includes the method of example 15, wherein the first iteration of the EDA tool determines a second efficiency metric for the clock path of the input circuit design, second efficiency metric based on clock activity associated with the clock path of the input circuit design, and the first efficiency metric is based on the gated power metric, the ungated power metric and the second efficiency metric.

Example 17 includes the method of example 16, further including determining a third efficiency metric based on a ratio of the gated power metric and the ungated power metric, and determining the first efficiency metric based on a ratio of the third efficiency metric and the second efficiency metric.

Example 18 includes the method of example 15, wherein the gated power metric is based on an upstream power metric for the clock path and a downstream power metric for the clock path, the upstream power metric and the downstream power metric relative to a clock buffer in the clock path.

Example 19 includes the method of example 18, wherein the clock buffer is a local clock buffer in the clock path, the upstream power metric estimates power utilization from a global clock buffer of the clock path to the local clock buffer, and the downstream power metric estimates power utilization from an output of the local clock buffer to a sequential logic cell driven by the local clock buffer, the upstream power metric to include power utilization of the local clock buffer, the downstream power metric to include power utilization of the sequential logic cell.

Example 20 includes the method of example 15, wherein the executing of the second iteration of the EDA tool with clock gating of the input circuit design disabled includes overriding clock gating in the clock path by causing downstream clocks in the clock path to be clocked at a rate of a root clock of the clock path, and setting a default toggle rate of zero for other logic gates and side input pins adjacent to the clock path.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory computer readable medium comprising computer readable instructions to cause programmable circuitry to at least:
execute a first iteration of an electronic design automation (EDA) tool with clock gating of an input circuit design enabled to determine a gated power metric for a clock path of the input circuit design;
execute a second iteration of the EDA tool with clock gating of the input circuit design disabled to determine an ungated power metric for the clock path of the input circuit design; and
output a first efficiency metric for the clock path of the input circuit design based on the gated power metric and the ungated power metric.

2. The at least one non-transitory computer readable medium of claim 1, wherein the first iteration of the EDA tool is to determine a second efficiency metric for the clock path of the input circuit design, the second efficiency metric based on clock activity associated with the clock path of the input circuit design, and the first efficiency metric is based on the gated power metric, the ungated power metric and the second efficiency metric.

3. The at least one non-transitory computer readable medium of claim 2, wherein the instructions are to cause the programmable circuitry to determine a third efficiency metric based on a ratio of the gated power metric and the ungated power metric, and the instructions are to cause the programmable circuitry to determine the first efficiency metric based on a ratio of the third efficiency metric and the second efficiency metric.

4. The at least one non-transitory computer readable medium of claim 1, wherein the gated power metric is based on an upstream power metric for the clock path and a downstream power metric for the clock path, the upstream power metric and the downstream power metric relative to a clock buffer in the clock path.

5. The at least one non-transitory computer readable medium of claim 4, wherein the clock buffer is a local clock buffer in the clock path, the upstream power metric is to estimate power utilization from a global clock buffer of the clock path to the local clock buffer, and the downstream power metric is to estimate power utilization from an output of the local clock buffer to a sequential logic cell driven by the local clock buffer, the upstream power metric to include power utilization of the local clock buffer, the downstream power metric to include power utilization of the sequential logic cell.

6. The at least one non-transitory computer readable medium of claim 4, wherein the instructions are to cause the programmable circuitry to output the upstream power metric for the clock path and the downstream power metric for the clock path.

7. The at least one non-transitory computer readable medium of claim 1, wherein to execute the second iteration of the EDA tool with clock gating of the input circuit design disabled, the instructions are to cause the programmable circuitry to:
override clock gating in the clock path by causing downstream clocks in the clock path to be clocked at a rate of a root clock of the clock path; and
set a default toggle rate of zero for other logic gates and side input pins adjacent to the clock path.

8. The at least one non-transitory computer readable medium of claim 1, wherein the clock path is a first clock path, the gated power metric is a first gated power metric, the ungated power metric is a first ungated power metric, the first efficiency metric is a first effective clock gating efficiency metric, and the instructions are to cause the programmable circuitry to:
execute the first iteration of the EDA tool with clock gating of the input circuit design enabled to determine respective gated power metrics for respective clock paths of the input circuit design, the respective gated power metrics including the first gated power metric for the first clock path;
execute the second iteration of the EDA tool with clock gating of the input circuit design disabled to determine respective ungated power metrics for the respective clock paths of the input circuit design, the respective ungated power metrics including the first ungated power metric for the first clock path; and
output respective effective clock gating efficiency metrics for the respective clock paths of the input circuit design, the respective effective clock gating efficiency metrics based on the respective gated power metric and the respective ungated power metric, the respective effective clock gating efficiency metrics including the first effective clock gating efficiency metric for the first clock path.

9. An apparatus comprising:
interface circuitry;
computer readable instructions; and
programmable circuitry to at least one of execute or instantiate the computer readable instructions to:
execute a first iteration of an electronic design automation (EDA) tool with clock gating of an input circuit design enabled to determine a gated power metric for a clock path of the input circuit design;
execute a second iteration of the EDA tool with clock gating of the input circuit design disabled to determine an ungated power metric for the clock path of the input circuit design; and
output a first efficiency metric for the clock path of the input circuit design based on the gated power metric and the ungated power metric.

10. The apparatus of claim 9, wherein the first iteration of the EDA tool is to determine a second efficiency metric for the clock path of the input circuit design, the second efficiency metric based on clock activity associated with the clock path of the input circuit design, and the first efficiency metric is based on the gated power metric, the ungated power metric and the second efficiency metric.

11. The apparatus of claim 10, wherein the programmable circuitry is to:
determine a third efficiency metric based on a ratio of the gated power metric and the ungated power metric; and
determine the first efficiency metric based on a ratio of the third efficiency metric and the second efficiency metric.

12. The apparatus of claim 9, wherein the gated power metric is based on an upstream power metric for the clock path and a downstream power metric for the clock path, the upstream power metric and the downstream power metric relative to a clock buffer in the clock path.

13. The apparatus of claim 12, wherein the clock buffer is a local clock buffer in the clock path, the upstream power metric is to estimate power utilization from a global clock buffer of the clock path to the local clock buffer, and the downstream power metric is to estimate power utilization from an output of the local clock buffer to a sequential logic cell driven by the local clock buffer, the upstream power metric to include power utilization of the local clock buffer, the downstream power metric to include power utilization of the sequential logic cell.

14. The apparatus of claim 9, wherein to execute the second iteration of the EDA tool with clock gating of the input circuit design disabled, the programmable circuitry is to:
override clock gating in the clock path by causing downstream clocks in the clock path to be clocked at a rate of a root clock of the clock path; and
set a default toggle rate of zero for other logic gates and side input pins adjacent to the clock path.

15. A method comprising:
executing a first iteration of an electronic design automation (EDA) tool with clock gating of an input circuit design enabled to determine a gated power metric for a clock path of the input circuit design;
executing a second iteration of the EDA tool with clock gating of the input circuit design disabled to determine an ungated power metric for the clock path of the input circuit design; and
outputting a first efficiency metric for the clock path of the input circuit design based on the gated power metric and the ungated power metric.

16. The method of claim 15, wherein the first iteration of the EDA tool determines a second efficiency metric for the clock path of the input circuit design, second efficiency metric based on clock activity associated with the clock path of the input circuit design, and the first efficiency metric is based on the gated power metric, the ungated power metric and the second efficiency metric.

17. The method of claim 16, further including:
determining a third efficiency metric based on a ratio of the gated power metric and the ungated power metric; and
determining the first efficiency metric based on a ratio of the third efficiency metric and the second efficiency metric.

18. The method of claim 15, wherein the gated power metric is based on an upstream power metric for the clock path and a downstream power metric for the clock path, the upstream power metric and the downstream power metric relative to a clock buffer in the clock path.

19. The method of claim 18, wherein the clock buffer is a local clock buffer in the clock path, the upstream power metric estimates power utilization from a global clock buffer of the clock path to the local clock buffer, and the downstream power metric estimates power utilization from an output of the local clock buffer to a sequential logic cell driven by the local clock buffer, the upstream power metric to include power utilization of the local clock buffer, the downstream power metric to include power utilization of the sequential logic cell.

20. The method of claim 15, wherein the executing of the second iteration of the EDA tool with clock gating of the input circuit design disabled includes:
overriding clock gating in the clock path by causing downstream clocks in the clock path to be clocked at a rate of a root clock of the clock path; and
setting a default toggle rate of zero for other logic gates and side input pins adjacent to the clock path.
